(19) United States
(12) Patent Application Publication
(10) Pub. No.: US 2015/0304395 A1
(43) Pub. Date: Oct. 22, 2015

(54) INFORMATION PROCESSING APPARATUS, INFORMATION PROCESSING METHOD AND PROGRAM

(71) Applicant: NEC Corporation, Minato-ku, Tokyo (JP)

(72) Inventors: HIROAKI INOUE, Tokyo (JP); TAKASHI TAKENAKA, Tokyo (JP)

(21) Appl. No.: 14/377,220

(22) PCT Filed: Apr. 17, 2013
(86) PCT No.: PCT/JP2013/061427

§ 371 Date: Aug. 7, 2014

(30) Foreign Application Priority Data
Apr. 18, 2012 (JP) 2012-095063

(51) Int. Cl. H04L 29/08

(52) U.S. Cl. CPC H04L 67/10

(57) ABSTRACT

An information processing apparatus comprises: a processing data retention unit that retains structural information representing structure of a message, collation information for collation against text information contained in the message, and processing information representing a content(s) of processing for the text information; and a message processing unit that construes a received message in accordance with the structural information, and transforms, in case text information contained in the received message coincides with the collation information, the text information contained in the received message in accordance with the processing information, and outputs a message containing the transformed text information.

### REFERENCE TO RELATED APPLICATION

This Application is a National Stage Entry of PCT/JP2013/061427 filed on Apr. 17, 2013, which claims priority from Japanese Patent Application 2012-095063, filed on Apr. 18, 2012, the content of all of which are incorporated herein by their reference, in their entirety.

### TECHNICAL FIELD

The present invention relates to an information processing apparatus, an information processing method, and a program. More particularly, it relates to an information processing apparatus, an information processing method, and a program for processing a structured message.

### BACKGROUND

There is recently a need to process the information derived from sensors or terminals in real time to create a new added value. In general, such information arrives at a server as a message. However, if a routine server has received a large amount of these messages, it is not possible for the server to implement processing in real-time. It is therefore necessary to extract the just messages containing the critical information in advance to process them on the server.

A related technique that is able to perform such extraction processing has been disclosed in e.g., Patent Literatures 1 and 2.

Patent Literature 1:

JP Patent Kokai Publication No. JP2007-310662A

Patent Literature 2:

JP Patent Kohyo Publication No. JP2004-531941A

### SUMMARY

The total contents disclosed in the above mentioned Patent Literatures are incorporated herein by reference. The following analysis has been made by the present inventor.

FIG. 14 illustrates schematics of the operations of the related techniques disclosed in the Patent Literatures 1 and 2. Referring to FIG. 14, the apparatus for performing the extraction processing, shown in the related techniques, includes a unit 101 for checking a message 102. The unit 101 checks the message 102 in accordance with the information of given specifications (design statements) and, if data that may become a subject for check is found in the message 102, the message is dropped. By so doing, it is possible to prevent a message, not containing any crucial information, from arriving at a server in case of occurrence of a large number of messages transmitted.

However, in the apparatus shown in FIG. 14, the messages are dropped in their entirety. Hence, even when unneeded data are contained in a fraction of the messages, it is not possible to remove just unneeded data before sending the messages to the server.

That is, the related techniques suffer from the problem that just the information needed cannot be extracted from the received messages. Moreover, in the related techniques, it is also difficult to extract just the needed information as a diversity of extraction conditions are flexibly dealt with. This may prove a hindrance in implementing an apparatus that processes messages flexibly at a high speed.

Therefore, there is a need in the art to enable just the crucial information to be extracted from the received messages.

According to a first aspect of the present invention, there is provided an information processing apparatus. The information processing apparatus comprises: a processing data retention unit that retains structural information representing structure of a message, collation information for collation against text information contained in the message, and processing information representing a content(s) of processing for the text information; and a message processing unit that construes a received message in accordance with the structural information, and transforms, in case text information contained in the received message coincides with the collation information, the text information contained in the received message in accordance with the processing information, and outputs a message containing the transformed text information.

According to a second aspect of the present invention, there is provided an information processing method. The information processing method comprises: by a computer, retaining in a memory unit structural information representing structure of a message, collation information for collation against text information contained in the message, and processing information representing a content(s) of processing for the text information; construing a received message in accordance with the structural information; transforming, in case text information contained in the received message coincides with the collation information, the text information contained in the received message in accordance with the processing information; and outputting a message containing the transformed text information.

According to a third aspect of the present invention, there is provided a program. The program causes a computer to execute: retaining in a memory unit structural information representing structure of a message, collation information for collation against text information contained in the message, and processing information representing a content(s) of processing for the text information; construing a received message in accordance with the structural information; transforming, in case text information contained in the received message coincides with the collation information, the text information contained in the received message in accordance with the processing information; and outputting a message containing the transformed text information.

It is noted that the program can be placed on the market as a program product recorded on a non-transient computer-readable storage medium.

The present invention provides the following advantage, but not restricted thereto. According to the information processing apparatus, the information processing method, and the program of the present invention, just crucial information can be extracted from the received messages.

### BRIEF DESCRIPTION OF THE DRAWINGS

FIG. 1 is a block diagram showing an example configuration of an information processing apparatus according to a First Exemplary Embodiment.

FIG. 2 is a block diagram showing an example configuration of an information processing apparatus according to the First Exemplary Embodiment in detail.

FIG. 3 is a block diagram showing an example configuration of an information processing apparatus according to a Second Exemplary Embodiment.

FIG. 4 is a block diagram showing an example configuration of the information processing apparatus according to the Second Exemplary Embodiment in detail.

FIG. 5 is a block diagram showing an example operation of the information processing apparatus according to the Second Exemplary Embodiment.

FIGS. 6A and 6B are tabulated views showing messages according to Examples.

FIG. 7 is a tabulated view showing an example configuration of a structure definition unit according to a First Example.

FIGS. 8A and 8B are tabulated views showing configurations of a selection data management unit and a transformation data management unit according to the First Example.

FIGS. 9A and 9B are tabulated views showing example messages following the transformation in the First Example.

FIGS. 10A and 10B are tabulated views showing configurations of a selection data management unit and a transformation data management unit according to a Second Example.

FIGS. 11A and 11B are tabulated views showing example messages following the transformation in the Second Example.

FIGS. 12A and 12B are tabulated views showing the configurations of the selection data management unit and the transformation data management unit according to a Third Example.

FIGS. 13A and 13B are tabulated views showing example messages following the transformation in the Third Example.

FIG. 14 is a schematic block diagram for illustrating the operation of a related technique.

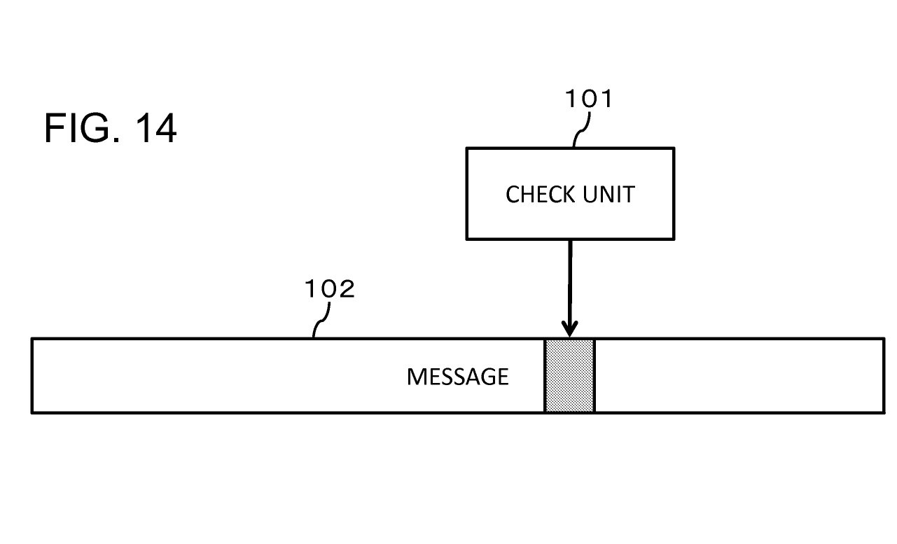

### MODES FOR CARRYING OUT THE INVENTION

In the present disclosure, there are various possible modes, which include the following, but not restricted thereto. Initially, a summary will be given of an exemplary embodiment. It is observed that symbols used in the summary for reference to the drawings are simply illustrations to assist in understanding and are not intended to limit the present invention to the modes illustrated.

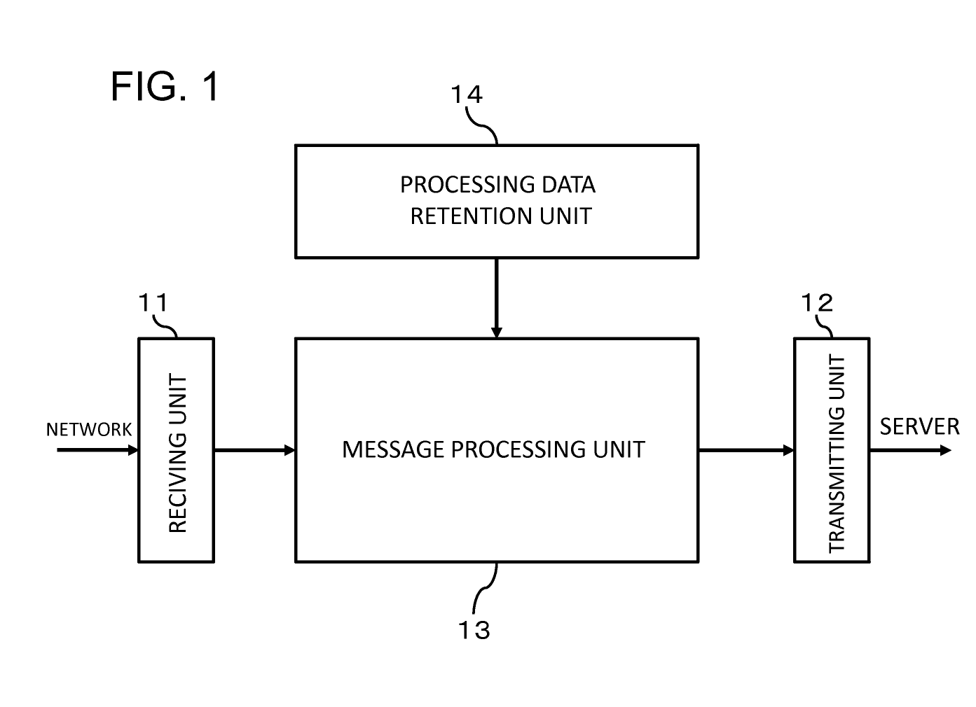

FIG. 1 shows a block diagram showing an example configuration of an information processing apparatus according to an exemplary embodiment. Referring to FIG. 1, the information processing apparatus is such a one that processes a structured message, and includes a receiving unit (11), a transmitting unit (12), a processing data retention unit (14) and a message processing unit (13).

The processing data retention unit (14) retains (holds) structure information, representing structure of a message, collation information for collation against text information contained in the message, and processing information representing a content(s) of processing on the text information.

The receiving unit (11) receives a message from the network to output it to the message processing unit (13). The message processing unit (13) extracts the crucial information from the message received from the receiving unit (11) in accordance with the information of the processing data retention unit (14), and generates a message containing the extracted information, which message is then output to the transmitting unit (12).

Specifically, the message processing unit (13) construes the received message in accordance with the structural information. In case text information contained in the received message coincides with the collation information, the message processing unit transforms the text information contained in the received message in accordance with the processing information to output a message containing the transformed text information to the transmitting unit (12). The transmitting unit transmits the message, received from the message processing unit (13), to the server.

In an exemplary embodiment of the information processing apparatus, if a body part in a message, excluding its header part, which body part is also termed a data or payload part, is a data string arranged in accordance with defined specifications, and the specifications of the data string are well-defined, it is possible to extract data contained in the message. Thus, in an information processing apparatus according to the exemplary embodiment, just the crucial information can be delivered to the server, so that it is possible to implement high-speed message processing on a server.

In a further exemplary embodiment of the information processing apparatus, management data, exemplified by the structural information, representing the message structure, the collation information for collation against the text information contained in the message and the processing information representing the contents of processing for the text information, are retained as entities that are independent of one another. Thus, by changing the management data, it is possible to flexibly implement diversified message processing.

The following modes are possible in the present invention.

Mode 1

An information processing apparatus may be the information processing apparatus according to the above mentioned first aspect of the present invention.

Mode 2

In the above information processing apparatus, the processing data retention unit may retain structural information representing arrangement of a field contained in a data part of a message, collation information for collation against text information contained in the field, and processing information representing a content(s) of processing for the text information contained in the field.

Mode 3

In the above information processing apparatus, the message processing unit may extract a field from a data part of the received message in accordance with the arrangement information, and transform, in case text information contained in the extracted field coincides with the collation information, the text information contained in the extracted field in accordance with the processing information, and output a message containing the transformed text information.

Mode 4

In the above information processing apparatus, the processing data retention unit may retain structural information representing arrangement of a plurality of fields contained in a data part of a message, collation information for collation against text information contained in the plurality of fields, and processing information representing a content(s) of processing for the text information contained in the plurality of fields.

Mode 5

In the above information processing apparatus, in case the data part of the received message contains a plurality of fields, the message processing unit may break down the plurality of fields into a plurality of separate fields in accordance with the arrangement information, and, in case text information contained in the plurality of separate fields coincides with the collation information, the message processing unit may transform the text information contained in the plurality of separate fields in accordance with the processing information, and output a message obtained by reconfiguring the plurality of separate fields containing the transformed text information in accordance with the arrangement information.

Mode 6

The above information processing apparatus may further comprise: a data rewriting unit that receives a command instructing changing the collation information and/or the processing information, retained by the processing data retention unit, and rewrites the collation information and/or the processing information in accordance with the command.

Mode 7

In the above information processing apparatus, the data rewriting unit may perform the rewriting at a timing of receiving no message(s).

Mode 8

In the above information processing apparatus, the contents of processing may include at least one of deletion, substitution, addition, duplication and sorting for at least a fraction of the text information contained in the message.

Mode 9

An information processing method may be the information processing method according to the above mentioned second aspect of the present invention.

Mode 10

In the above information processing method, the memory unit may retain structural information representing arrangement of a field contained in a data part of a message, collation information for collation against text information contained in the field, and processing information representing a content(s) of processing for the text information contained in the field.

Mode 11

The above information processing method may comprise: by the computer, extracting a field from a data part of the received message in accordance with the arrangement information; transforming, in case text information contained in the extracted field coincides with the collation information, the text information contained in the extracted field in accordance with the processing information; and outputting a message containing the transformed text information.

Mode 12

In the above information processing method, the memory unit may retain structural information representing arrangement of a plurality of fields contained in a data part of a message, collation information for collation against text information contained in the plurality of fields, and processing information representing a content(s) of processing for the text information contained in the plurality of fields.

Mode 13

The above information processing method may comprise: by the computer, breaking down, in case the data part of the received message contains a plurality of fields, the plurality of fields into a plurality of separate fields in accordance with the arrangement information; transforming, in case text information contained in the plurality of separate fields coincides with the collation information, the text information contained in the plurality of separate fields in accordance with the processing information; and outputting a message obtained by reconfiguring the plurality of separate fields containing the transformed text information in accordance with the arrangement information.

Mode 14

The above information processing method may comprise: by the computer, receiving a command instructing changing the collation information and/or the processing information retained by the memory unit; and rewriting the collation information and/or the processing information in accordance with the command.

Mode 15

In the above information processing method, the computer may perform the rewriting at a timing of receiving no message(s).

Mode 16

A program may be the program according to the above mentioned third aspect of the present invention.

Mode 17

In the above program, the memory unit may retain structural information representing arrangement of a field contained in a data part of a message, collation information for collation against text information contained in the field, and processing information representing a content(s) of processing for the text information contained in the field.

Mode 18

The above program may cause the computer to execute: extracting a field from a data part of the received message in accordance with the arrangement information; transforming, in case text information contained in the extracted field coincides with the collation information, the text information contained in the extracted field in accordance with the processing information; and outputting a message containing the transformed text information.

Mode 19

In the above program, the memory unit may retain structural information representing arrangement of a plurality of fields contained in a data part of a message, collation information for collation against text information contained in the plurality of fields, and processing information representing a content(s) of processing for the text information contained in the plurality of fields.

Mode 20

The above program may cause the computer to execute: breaking down, in case the data part of the received message contains a plurality of fields, the plurality of fields data into a plurality of separate fields in accordance with the arrangement information; transforming, in case text information contained in the plurality of separate fields coincides with the collation information, the text information contained in the plurality of separate fields in accordance with the processing information; and outputting a message obtained by reconfiguring the plurality of separate fields containing the transformed text information in accordance with the arrangement information.

Mode 21

The above program may cause the computer to execute: receiving a command instructing changing the collation information and/or the processing information retained by the memory unit; and rewriting the collation information and/or the processing information in accordance with the command.

Mode 22

The above program may cause the computer to execute the rewriting at a timing of receiving no message(s).

### First Exemplary Embodiment

An information processing apparatus according to a First Exemplary Embodiment will now be described with reference to the drawings. FIG. 1 depicts a block diagram showing an example configuration of an information processing apparatus 1 of the present exemplary embodiment. Referring to FIG. 1, the information processing apparatus includes a receiving unit 11, a transmitting unit 12, a message processing unit 13 and a processing data retention unit 14.

The receiving unit 11 receives a message from a network and delivers the received message to the message processing unit 13.

The transmitting unit 12 forwards the output message from the message processing unit 13 via a communication path within a server, such as PCI Express (Peripheral Component Interconnect Express), to a CPU (Central Processing Unit) or a memory within the server.

The message processing unit 13 performs information processing operations for the messages in accordance with the information supplied from the processing data retention unit 14. These processing operations may include dropping the messages received from the receiving unit 11, extracting the crucial information contained in the messages and so forth.

The processing data retention unit 14 retains a diversity of the information regarding the selection and transformation of the messages, as management data. Examples of the management data include the information regarding the specifications of messages, the information regarding the messages to be selected, the information regarding the processing of the messages selected and so forth. The processing data retention unit delivers the management data it is retaining to the message processing unit 13.

The processing data retention unit 14 retaining the management information is separately provided as an independent component, as shown in FIG. 1. By so doing, a variety of the information may be extracted with flexibility simply by changing the contents of the management data.

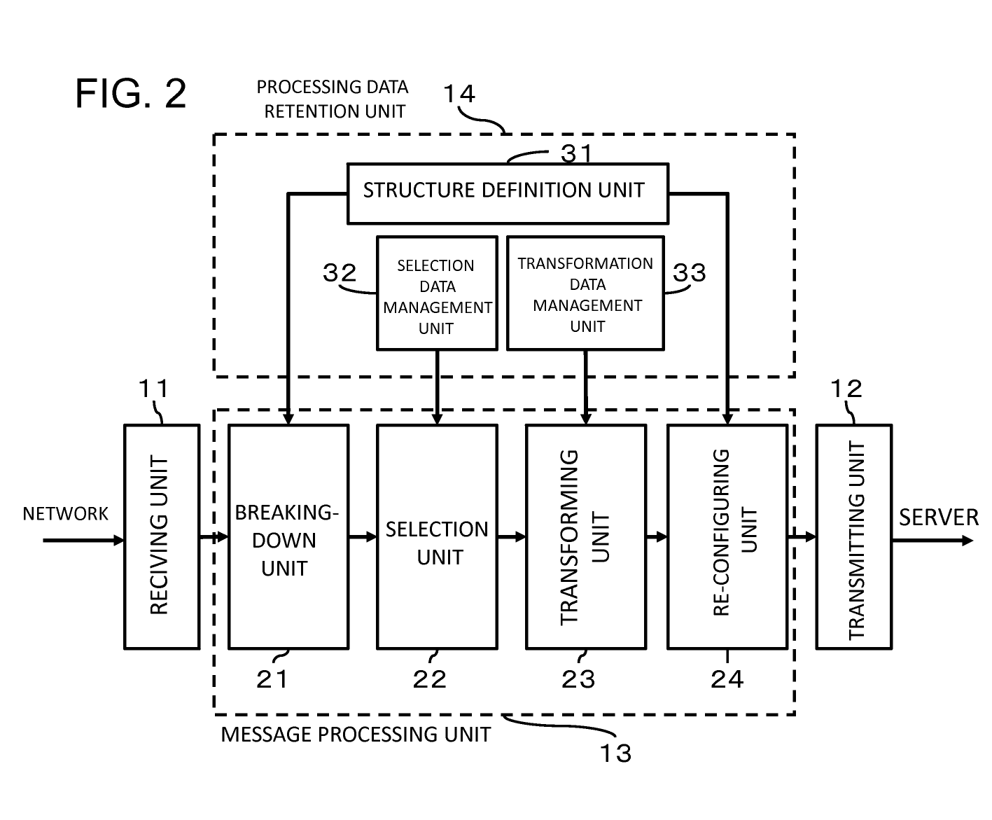

FIG. 2 depicts a block diagram showing a detailed example configuration of an information processing apparatus of the subject exemplary embodiment. Referring to FIG. 2, the message processing unit 13 includes a breaking-down unit 21, a selection unit 22, a transforming unit 23 and a re-configuring unit 24. The processing data retention unit 14 includes a structure definition unit 31, a selection data management unit 32 and a transformation data management unit 33.

The breaking-down unit 21 breaks down a message, received from the receiving unit 11, into respective fields of a header part and those of a data part (payload) in the message in accordance with the message specifications delivered from the structure definition unit 31. The breaking-down unit 21 delivers the resulting fields to the selection unit 22. In generic messages at large, the specifications of the data part are undetermined, so that it has been difficult to break down the data part on the field basis. However, the present exemplary embodiment has to do with the message configured in accordance with defined specifications, from the outset, so that it is possible to break down even the data part on the field basis.

On receipt of the message, thus broken down by the breaking-down unit 21, the selection unit 22 performs checking based on the message information that has been supplied from the selection data management unit 32 as a subject for checking. The selection unit delivers to the transforming unit 23 the results of a decision as to whether or not processing is to be performed regarding the message.

The transforming unit 23 performs preset processing, based on the message, received from the selection unit 22 in the broken down state, the results of the decision as to whether or not processing is to be performed, and on the message transforming processing information from the transformation data management unit 33. The transforming unit delivers the transformed message to the re-configuring unit 24.

The re-configuring unit 24 re-configures the fields of the transformed message, delivered from the transforming unit 23, and puts them together again into a message which is then delivered to the transmitting unit 12.

In the information processing apparatus of the present exemplary embodiment, which deals with a data string, contained in the message and constructed in accordance with the defined specifications, as a subject of checking, it is possible to extract data in the message. Thus, according to the information processing apparatus of the present exemplary embodiment, just the crucial information can be delivered to the server, even though a large volume of the message information has been received, thus assuring high-speed message processing on the server.

### Second Exemplary Embodiment

An information processing apparatus according to a Second Exemplary Embodiment will now be described with reference to the drawings. The present exemplary embodiment has a function of flexibly changing the message transforming processing from an application on board the server.

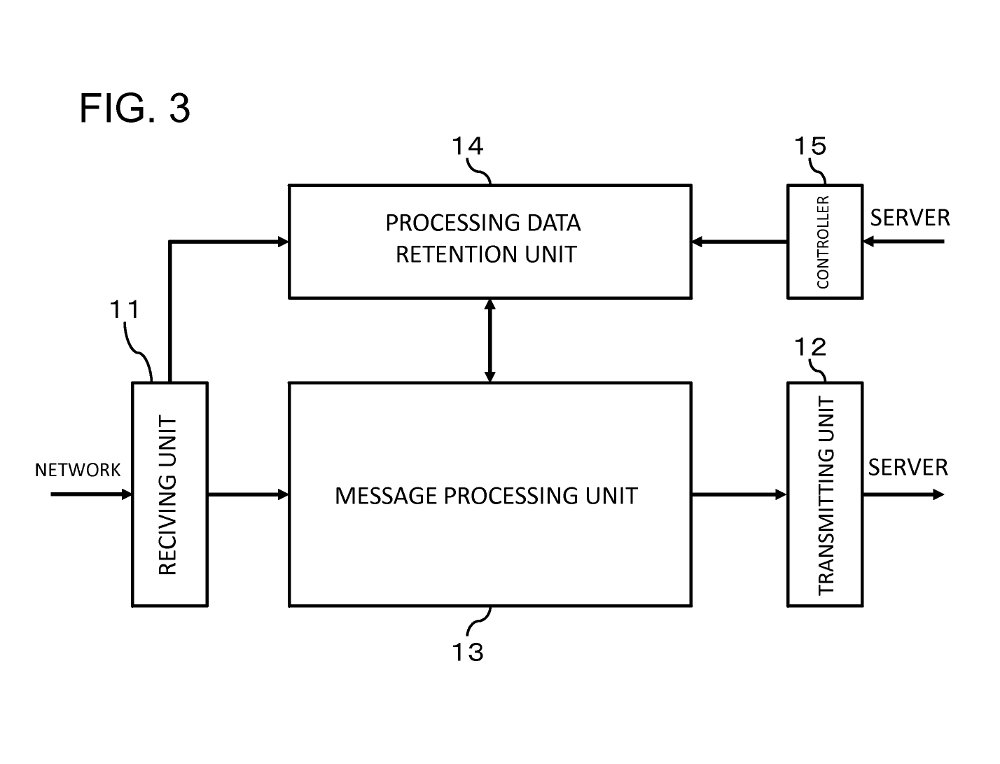

FIG. 3 shows a block diagram showing an example configuration of the information processing apparatus of the present exemplary embodiment. Referring to the drawings, the information processing apparatus includes a receiving unit 11, a transmitting unit 12, a message processing unit 13, a processing data retention unit 14 and a controller 15.

The receiving unit 11, transmitting unit 12 and the message processing unit 13 are similar in configuration to the corresponding units of the information processing apparatus of the First Exemplary Embodiment (FIG. 1).

The controller 15 accepts a data update request from the server and updates the processing data retention unit 14 in accordance with the request. The message information needed can be changed at any desired time by a user updating the contents of the processing data retention unit 14 by means of the controller 15.

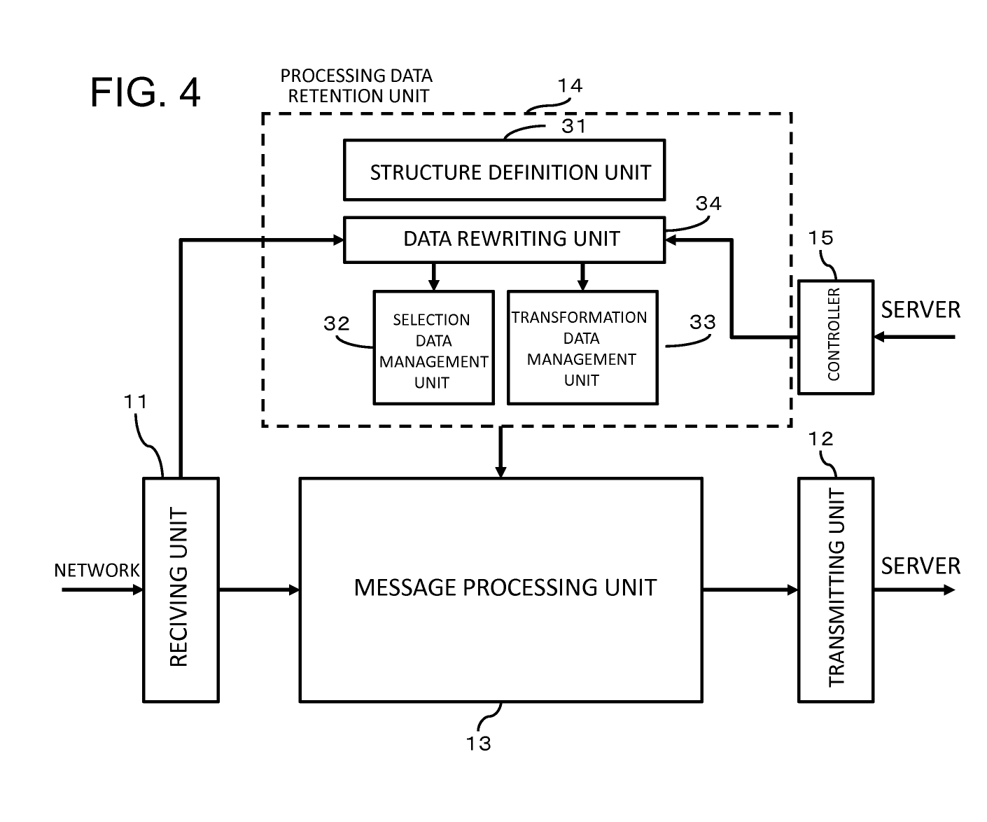

FIG. 4 shows a block diagram showing an example configuration of the information processing apparatus of the present exemplary embodiment in detail. Referring to FIG. 4, the processing data retention unit 14 includes a data rewriting unit 34 in addition to a structure definition unit 31, a selection data management unit 32 and a transformation data management unit 33.

The data rewriting unit 34 receives new selection management data and new transformation management data from the controller 15. At the same time, the data rewriting unit receives the current message delivery state from the receiving unit 11 and, based on these information, updates the management information in the selection data management unit 32 and the transformation data management unit 33 at a time point when no message is being received or at a time point as specified by the server.

Since this enables the two data to be changed simultaneously, it becomes possible to realize more consistent message selection and transformation. Moreover, the contents of the processing data retention unit 14 can be updated by the data rewriting unit 34 updating data in concert with the receiving unit 11, at a time point when no message is being received.

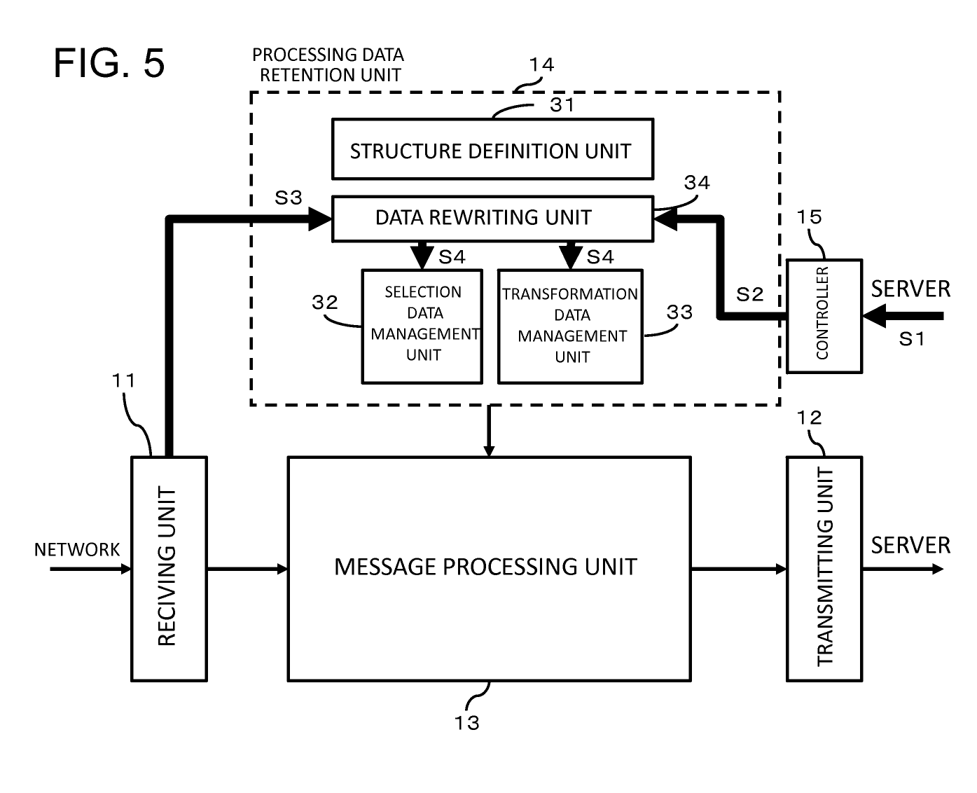

FIG. 5 shows an example operation of the information processing apparatus of the present exemplary embodiment. FIG. 5 shows an update operation for FIG. 4. Of course, the present operation is merely illustrative and any system may be used provided that the system used allows synchronous data update by a concerted operation with the receiving unit 11.

Initially, the controller 15 receives new selection management data and new transformation data from the application on-board the server (step S1).

The controller 15 then transmits the information, received from the application on the server, to the data rewriting unit 34 (step S2).

The receiving unit 11 informs to the data rewriting unit 34 that the receiving unit is currently receiving no message(s) (step S3).

The data rewriting unit 34 updates the selection data management unit 32 and the transformation data management unit 33 to the new information (step S4).

### First Example

More detailed operations of the information processing apparatus according to above described First and Second Exemplary Embodiments will now be described as a First Example.

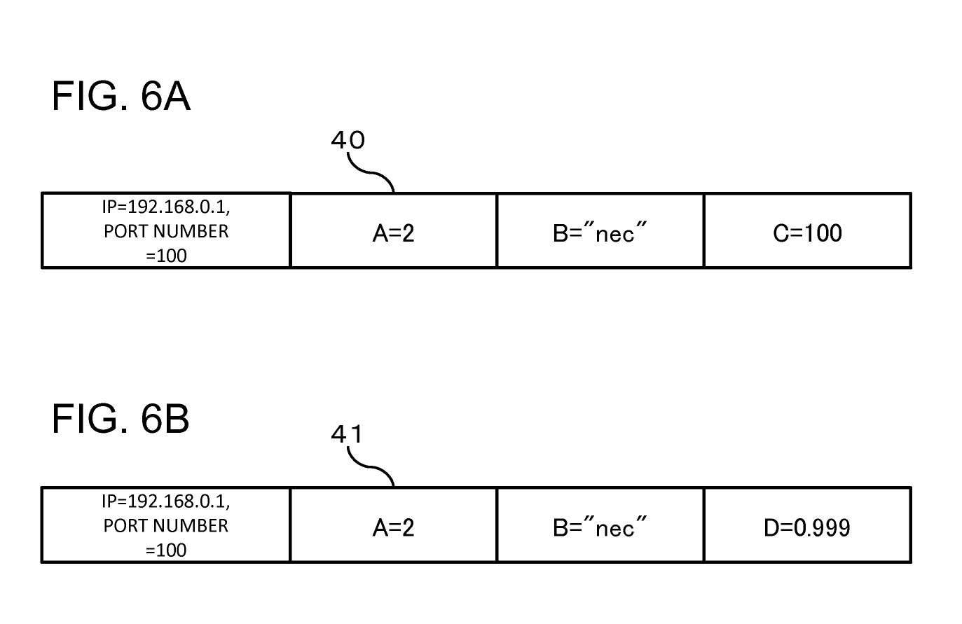

FIGS. 6A and 6B show examples of messages of the present Example. Referring to FIG. 6A, a message 40 includes a header part in which an IP (Internet Protocol) address is 192.168.0.1 and a port number is 100, and a data part in which values of attributes A, B and C are respectively 2, nec and 100. On the other hand, referring to FIG. 6B, a message 41 includes a header part in which an IP address is 192.168.0.1 and a port number is 100, like the message 40, and a data part in which the values of attributes A, B and D are respectively 2, nec and 0.999. In this case, the messages 40, 41 differ from each other as to whether the message has the attribute C or the attribute D.

It is noted that each of the messages 40, 41 is constructed in accordance with defined specifications that a data part thereof includes a plurality of sets of attributes and values demarcated from each other by a partitioning symbol ‘=’. In the present Example, such message is termed a ‘structured message’. Examples of the structured messages include messages formed by language specifications, such as HTML (Hypertext Markup Language) or XML (Extensible Markup Language), messages formed by keys and values, such as those used in the present exemplary embodiment, and otherwise. At any rate, by focusing the attention just on the structured messages, it becomes possible to extract the crucial information.

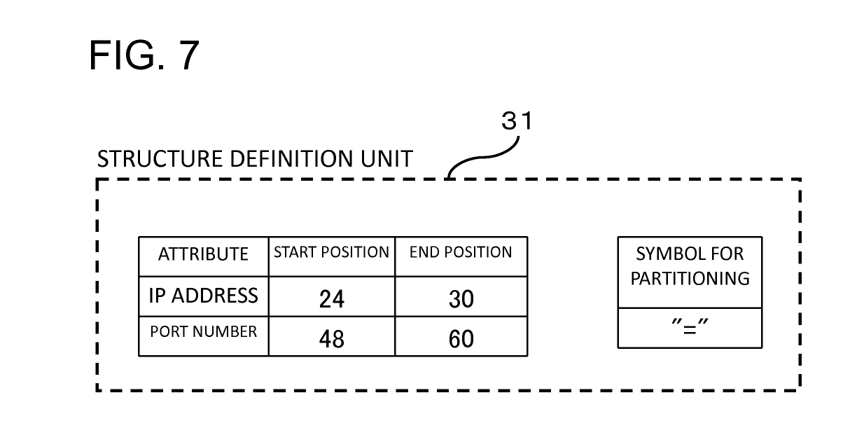

FIG. 7 shows an example configuration of the structure definition unit 31 in the present Example. Referring to FIG. 7, it is indicated that the structure definition unit 31 includes a site for storage of the header information of the message to be referred to and a constructive style of the data part of the message. For example, it is indicated in FIG. 7 that the beginning position and the end position of the IP address in the header part of the message are respectively the twenty-fourth and the thirtieth bytes, with the beginning position and the end position of the port number in the header part being respectively the forty-eighth and the sixtieth bytes. It is also indicated that the data part of the message includes one or more sets of attributes and values separated from each other by a partitioning symbol ‘=’.

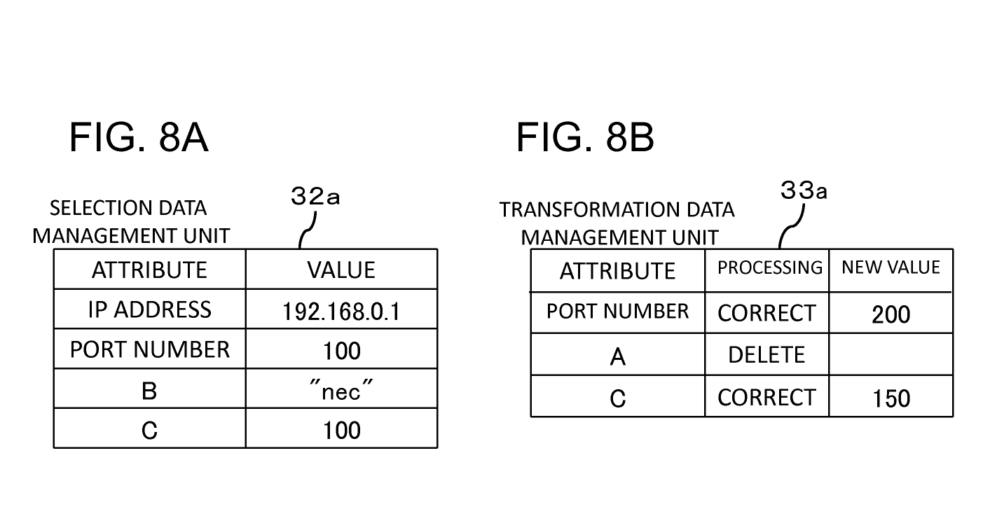

FIGS. 8A and 8B depict tables retained by a selection data management unit 32a and a transformation data management unit 33a in the present Example. Referring to FIG. 8A, the subject of processing in the selection data management unit 32a is a message having an IP address of 192.168.0.1, a port number of 100, a value of an attribute B of nec and a value of an attribute C of 100. Referring to FIG. 8B, a series of processing operations to be performed by the transformation data management unit 33a is prescribed. This series of the processing operations comprises correcting the port number to 200, deleting the attribute A and correcting the value of the attribute C to 150.

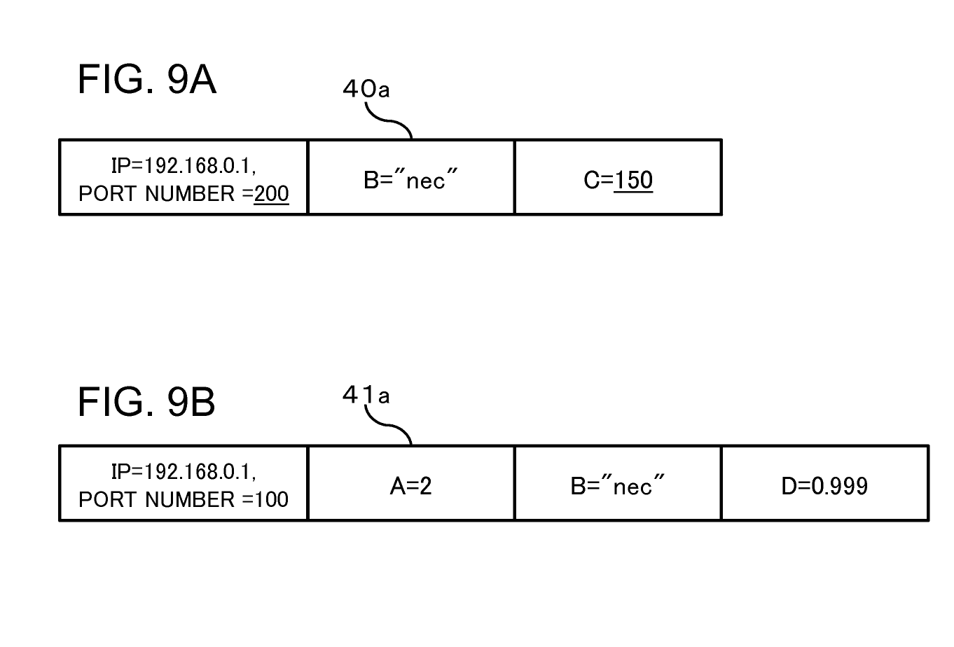

FIGS. 9A and 9B show transformed messages 40a, 41a following the transformation in the present Example. Referring to FIG. 9A, the selection data management unit 32a of FIG. 8A and the transformation data management unit 33a of FIG. 8B transform the message 40 of FIG. 6A into the message 40a, in which a certain value has been changed and the attribute A deleted. On the other hand, the message 41 of FIG. 6B is output unchanged, viz., as the message 41a, as shown in FIG. 9B.

### Second Example

More detailed operations of the information processing apparatus according to the above described First and Second Exemplary Embodiments will now be described as a Second Example.

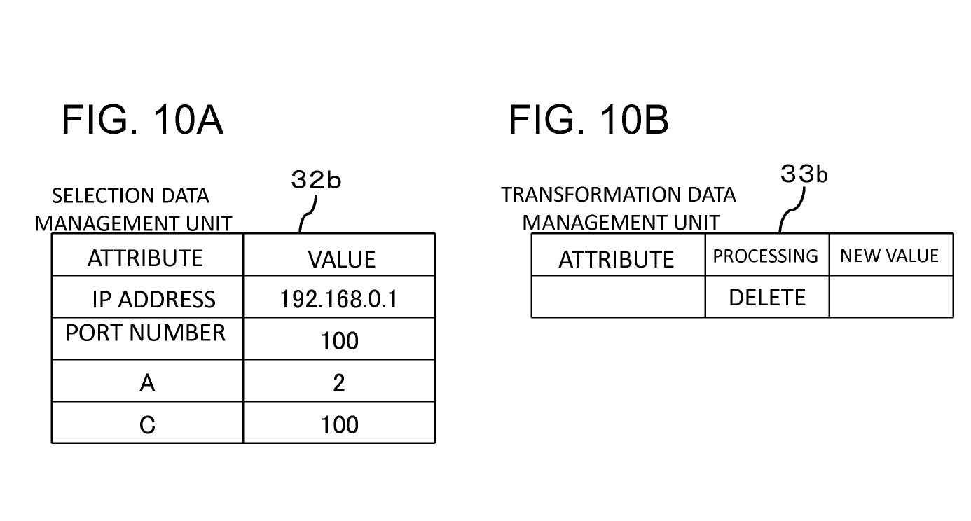

FIGS. 10A and 10B show tables respectively retained by the selection data management unit 32b and the transformation data management unit 33b of the present Example. Referring to FIG. 10A, the selection data management unit 32b prescribes a message, having an IP address of 192.168.0.1, a port number of 100, a value of an attribute A of 2 and a value of the attribute C of 100, as a subject of processing. Referring to FIG. 10B, the transformation data management unit 33b prescribes that the entire message is to be dropped.

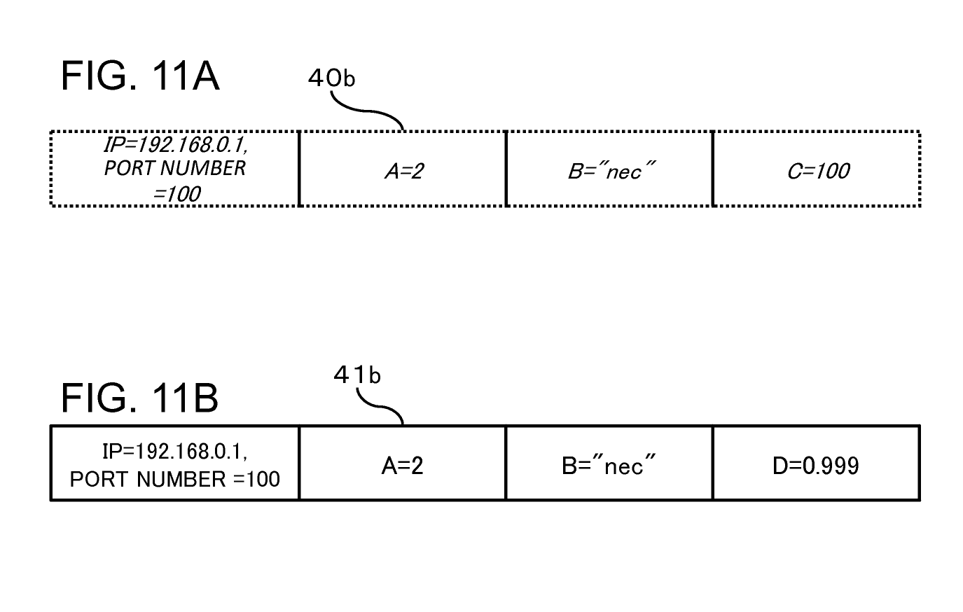

FIGS. 11A and 11B respectively show messages 40b, 41b transformed according to the present Example. Referring to FIG. 11A, the message 40 of FIG. 6A is dropped by the selection data management unit 32b of FIG. 10A and the transformation data management unit 33b of FIG. 10B. On the other hand, the message 41 of FIG. 6B is output unchanged, as the message 41b, as shown in FIG. 11B.

### Third Example

More concrete operations of the information processing apparatus according to the above mentioned First and Second Exemplary Embodiments will now be described as a Third Example.

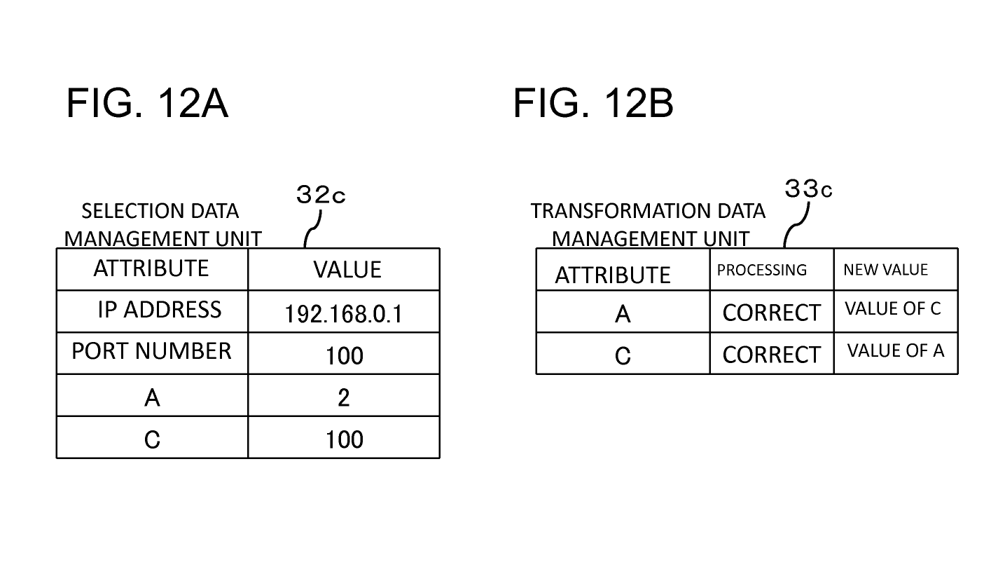

FIGS. 12A and 12B show tables retained respectively by a selection data management unit 32c and a transformation data management unit 33c of the present Example. Referring to FIG. 12A, the selection data management unit 32c prescribes a message having an IP address of 192.168.0.1, a port number of 100, a value of an attribute A of 2 and a value of an attribute C of 100, as a subject of processing. Referring to FIG. 12B, the transformation data management unit 33c prescribes a series of processing operations that corrects the value of the attribute A to the value of the attribute C and the value of the attribute C to the value of the attribute A.

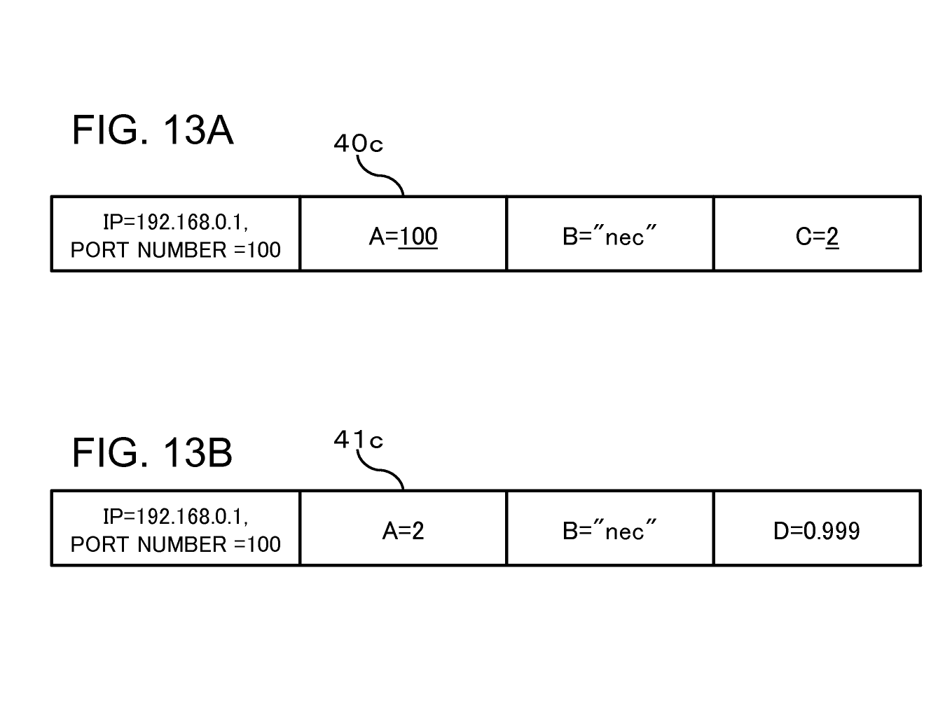

FIG. 13 shows messages 40c, 41c transformed according to the present Example. Referring to FIG. 13A, a value of the attribute A and that of the attribute C in the message 40 of FIG. 6A are respectively replaced by 100 and by 2 by the selection data management unit 32c of FIG. 12A and the transformation data management unit 33c of FIG. 12B. On the other hand, the message 41 of FIG. 6B is output unchanged, as the message 41c, as shown in FIG. 13B.

As mentioned above, any processing operations, such as addition, duplication (copying), deletion, substitution or sorting (re-arraying), or combinations thereof, can be performed on a data part of a message, provided that the processing operations are generic ones regarding data strings of the data part of the message. Thus, messages can be flexibly transformed with the information processing apparatus of the above described exemplary embodiments 1, 2.

The particular exemplary embodiments or examples may be changed or adjusted within the gamut of the entire disclosure of the present invention, inclusive of claims and drawings, based on the fundamental technical concept of the invention. Moreover, a variety of combinations or selection of elements herein disclosed (elements of claims, Examples and drawings) may be made within the concept of the claims of the present invention. Viz., it is to be noted that the present invention may include a variety of changes or corrections that may occur to those skilled in the art in accordance with the total disclosures inclusive of the claims and the drawings as well as the technical concept of the invention. In particular, it should be understood that, as regards the ranges of numerical values set out herein, any optional numerical figures or sub-ranges contained in the ranges are in fact specifically stated even in the absence of explicit statements.

11 receiving unit

12 transmitting unit

13 message processing unit

14 processing data retention unit

15 controller

21 breaking-down unit

22 selection unit

23 transforming unit

24 re-configuring unit

31 structure definition unit

32, 32a, 32b, 32c selection data management unit

33, 33a, 33b, 33c transformation data management unit

34 data rewriting unit

40, 40a to 40c, 41, 41a to 41c message

101 check unit

102 message

What is claimed is:

1. An information processing apparatus, comprising:
a processing data retention unit that retains structural information representing structure of a message, collation information for collation against text information contained in the message, and processing information representing a content(s) of processing for the text information; and
a message processing unit that construes a received message in accordance with the structural information, and transforms, in case text information contained in the received message coincides with the collation information, the text information contained in the received message in accordance with the processing information, and outputs a message containing the transformed text information.

2. The information processing apparatus according to claim 1, wherein,
the processing data retention unit retains structural information representing arrangement of a field contained in a data part of a message, collation information for collation against text information contained in the field, and processing information representing a content(s) of processing for the text information contained in the field.

3. The information processing apparatus according to claim 2, wherein,
the message processing unit extracts a field from a data part of the received message in accordance with the arrangement information, and transforms, in case text information contained in the extracted field coincides with the collation information, the text information contained in the extracted field in accordance with the processing information, and outputs a message containing the transformed text information.

4. The information processing apparatus according to claim 2, wherein,
the processing data retention unit retains structural information representing arrangement of a plurality of fields contained in a data part of a message, collation information for collation against text information contained in the plurality of fields, and processing information representing a content(s) of processing for the text information contained in the plurality of fields.

5. The information processing apparatus according to claim 4, wherein,
in case the data part of the received message contains a plurality of fields, the message processing unit breaks down the plurality of fields into a plurality of separate fields in accordance with the arrangement information, and, in case text information contained in the plurality of separate fields coincides with the collation information, the message processing unit transforms the text information contained in the plurality of separate fields in accordance with the processing information, and outputs a message obtained by reconfiguring the plurality of separate fields containing the transformed text information in accordance with the arrangement information.

6. The information processing apparatus according to claim 1, further comprising:
a data rewriting unit that receives a command instructing changing the collation information and/or the processing information, retained by the processing data retention unit, and rewrites the collation information and/or the processing information in accordance with the command.

7. The information processing apparatus according to claim 6, wherein,
the data rewriting unit performs the rewriting at a timing of receiving no message(s).

8. The information processing apparatus according to claim 1, wherein,
the content(s) of processing include at least one of deletion, substitution, addition, duplication and sorting for at least a fraction of the text information contained in the message.

9. An information processing method, comprising:
by a computer, retaining in a memory unit structural information representing structure of a message, collation information for collation against text information contained in the message, and processing information representing a content(s) of processing for the text information;
construing a received message in accordance with the structural information;
transforming, in case text information contained in the received message coincides with the collation information, the text information contained in the received message in accordance with the processing information; and
outputting a message containing the transformed text information.

10. The information processing method according to claim 9, wherein,
the memory unit retains structural information representing arrangement of a field contained in a data part of a message, collation information for collation against text information contained in the field, and processing information representing a content(s) of processing for the text information contained in the field.

11. The information processing method according to claim 10, comprising:
by the computer, extracting a field from a data part of the received message in accordance with the arrangement information;
transforming, in case text information contained in the extracted field coincides with the collation information, the text information contained in the extracted field in accordance with the processing information; and
outputting a message containing the transformed text information.

12. The information processing method according to claim 10, wherein,
the memory unit retains structural information representing arrangement of a plurality of fields contained in a data part of a message, collation information for collation against text information contained in the plurality of fields, and processing information representing a content(s) of processing for the text information contained in the plurality of fields.

13. The information processing method according to claim 12, comprising:
by the computer, breaking down, in case the data part of the received message contains a plurality of fields, the plurality of fields into a plurality of separate fields in accordance with the arrangement information;
transforming, in case text information contained in the plurality of separate fields coincides with the collation information, the text information contained in the plurality of separate fields in accordance with the processing information; and
outputting a message obtained by reconfiguring the plurality of separate fields containing the transformed text information in accordance with the arrangement information.

14. The information processing method according to claim 9, comprising:
by the computer, receiving a command instructing changing the collation information and/or the processing information retained by the memory unit; and
rewriting the collation information and/or the processing information in accordance with the command.

15. The information processing method according to claim 14, wherein,
the computer performs the rewriting at a timing of receiving no message(s).

16. A non-transitory computer-readable recording medium, storing a program, that causes a computer to execute:
retaining in a memory unit structural information representing structure of a message, collation information for collation against text information contained in the message, and processing information representing a content(s) of processing for the text information;
construing a received message in accordance with the structural information;
transforming, in case text information contained in the received message coincides with the collation information, the text information contained in the received message in accordance with the processing information; and
outputting a message containing the transformed text information.

17. The non-transitory computer-readable recording medium according to claim 16, wherein,
the memory unit retains structural information representing arrangement of a field contained in a data part of a message, collation information for collation against text information contained in the field, and processing information representing a content(s) of processing for the text information contained in the field.

18. The non-transitory computer-readable recording medium according to claim 17, wherein
the program causes the computer to execute:
extracting a field from a data part of the received message in accordance with the arrangement information;
transforming, in case text information contained in the extracted field coincides with the collation information, the text information contained in the extracted field in accordance with the processing information; and
outputting a message containing the transformed text information.

19. The non-transitory computer-readable recording medium according to claim 17, wherein,
the memory unit retains structural information representing arrangement of a plurality of fields contained in a data part of a message, collation information for collation against text information contained in the plurality of fields, and processing information representing a content(s) of processing for the text information contained in the plurality of fields.

20. The non-transitory computer-readable recording medium according to claim 19, wherein
the program causes the computer to execute:
breaking down, in case the data part of the received message contains a plurality of fields, the plurality of fields data into a plurality of separate fields in accordance with the arrangement information;
transforming, in case text information contained in the plurality of separate fields coincides with the collation information, the text information contained in the plurality of separate fields in accordance with the processing information; and
outputting a message obtained by reconfiguring the plurality of separate fields containing the transformed text information in accordance with the arrangement information.

21-22. (canceled)
